(19) United States
(12) Patent Application Publication
(10) Pub. No.: US 2026/0349688 A1
(43) Pub. Date: Nov. 5, 2026

(54) AI-BASED SYSTEM AND METHOD FOR AUTOMATIC UI/UX GENERATION, AND PROGRAM TO PERFORM THE SAME

(71) Applicant: INSWAVE CO., LTD., Seoul (KR)

(72) Inventors: Se Yong EO, Seoul (KR); Woog Lae KIM, Seoul (KR)

(21) Appl. No.: 19/450,724

(22) Filed: Jan. 16, 2026

(30) Foreign Application Priority Data
Jan. 17, 2025 (KR) 10-2025-0007039

(51) Int. Cl. G06F 8/38; G06F 8/35

(52) U.S. Cl. CPC G06F 8/38; G06F 8/35

(57) ABSTRACT

AI-based system and method for automatic UI/UX generation, and a program to perform the same disclosed. A non-transitory computer-readable medium storing computer executable instructions for performing an AI-based method for automatic UI/UX generation when executed by a computer, wherein the instructions cause the computer to perform the following steps: building a snippet database including a plurality of snippets that comply with design guidelines; receiving an original design file; analyzing the original design file using an AI model; matching a snippet corresponding to a designated recommendation criterion by comparing with the plurality of snippets stored in the snippet database based on a result of the analysis; and automatically generating a UI/UX source embedding the design guidelines by combining information on the matched snippet and elements of the original design file.

### CROSS-REFERENCE TO RELATED APPLICATION

The present application claims priority under 35 U.S.C. § 119(a) to Korean application number 10-2025-0007039, filed on Jan. 17, 2025, in the Korean Intellectual Property Office, which is incorporated herein by reference in its entirety.

### BACKGROUND

The present invention relates to an AI(Artificial intelligence)-based system and method for automatic UI/UX generation, and a program to perform the same.

There is a demand for converting an arbitrary image or design into UI (user interface) code. Conventionally, there have been several attempts to automatically generate HTML/CSS/JS code based on visual elements extracted from image or design tools.

However, code created by simply mimicking pixel-level elements has a problem in that it is difficult to strictly comply with design guidelines. As a result, the reusability and maintainability of the generated code are significantly low, thereby imposing a limitation in that excessive cost and time must subsequently be expended for manual rework by a human operator to conform to design guidelines.

The matters described in the background are intended solely to aid in the understanding of the background of the invention and are not necessarily to be construed as prior art already known to those skilled in the art.

### SUMMARY

An object of the present invention is to provide an AI-based system and method for automatic UI/UX generation and a program to perform the same, which build a snippet database in which design guidelines are reflected, analyze design results (such as images or Figma) input from an AI model to receive matching or recommendations for appropriate snippets, and allow a user to review and modify to generate a final UI/UX source.

An object of the present invention is to provide an AI-based system and method for automatic UI/UX generation and a program to perform the same, which can rapidly generate high-quality UI/UX and improve development efficiency and consistency by maintaining design guidelines even during maintenance.

Other objects of the present invention will become more apparent through preferred embodiments described below.

According to one aspect of the present invention, there is provided a non-transitory computer-readable medium storing computer executable instructions for performing an AI-based method for automatic UI/UX generation when executed by a computer, wherein the instructions cause the computer to perform the following steps: building a snippet database including a plurality of snippets that comply with design guidelines; receiving an original design file; analyzing the original design file using an AI model; matching a snippet corresponding to a designated recommendation criteria among the plurality of snippets stored in the snippet database based on the analysis results; and automatically generating a UI/UX source embedding the design guidelines by combining information on the matched snippet and elements of the original design file.

The snippet may be a predefined basic unit used when configuring UI or UX and the design guidelines include at least one of color, spacing, font, or layout rules.

In the building of the snippet database, the snippets similar to each other above a threshold may be grouped in consideration of functional features and visual features.

The original design file may be one or more of an image file and a file in a designated format exported from a design tool.

In the analyzing of the original design file, the AI model may be configured to analyze the original design file to distinguish an in-screen element, and extract and classify one or more attributes among coordinates, size, color, and font of the in-screen element.

In the matching of the snippet, the recommendation criterion may be at least one of containing a majority of the in-screen elements or having the smallest error in the comparison values of attributes such as coordinates, size, color, and font for each in-screen element.

The AI-based method for automatic UI/UX generation may further include providing a matching result of the snippet by visualizing the result as a UI after the matching of the snippet; and editing the snippet by a user input.

According to another aspect of the present invention, there is provided an AI-based system for automatic UI/UX generation including a snippet database construction unit configured to build a snippet database including a plurality of snippets that comply with design guidelines; a design analysis unit configured to receive an original design file and analyzing the original design file using an AI model; a snippet matching unit configured to match a snippet corresponding to a designated recommendation criteria among the plurality of snippets stored in the snippet database based on the analysis; and a source generation unit configured to automatically generate a UI/UX source embedding the design guidelines by combining information on the matched snippet and elements of the original design file.

The AI model may be configured to analyze the original design file to distinguish an in-screen element, and extract and classify one or more attributes among coordinates, size, color, and font of the in-screen element.

The recommendation criterion may be at least one of containing a majority of the in-screen elements or having the smallest error in the comparison values of attributes such as coordinates, size, color, and font for each in-screen element.

The snippet matching unit may be further configured to provide a matching result of the snippet by visualizing the result as a UI after the matching of the snippet and edit the snippet by a user input.

Other aspects, features, and advantages than those described above will become apparent from the following drawings, claims, and detailed description of the invention.

According to one embodiment of the present invention, it is advantageous in that a snippet database reflecting design guidelines is constructed, design outputs (such as images or Figma files) input from an AI model are analyzed to match or recommend suitable snippets, and a user reviews and modifies the snippets to thereby generate a final UI/UX source.

In addition, it is also advantageous in rapidly generating high-quality UI/UX and improving development efficiency and consistency by maintaining design guidelines even during maintenance.

The effects obtainable from the present invention are not limited to the effects mentioned above, and other unmentioned effects will be clearly understood by those with ordinary skill in the art to which the present invention pertains from the description below.

### BRIEF DESCRIPTION OF THE DRAWINGS

FIG. 1 illustrates an AI-based system for automatic UI/UX generation according to one embodiment of the present invention,

FIG. 2 is a flowchart of an AI-based method for automatic UI/UX generation according to one embodiment of the present invention,

FIG. 3 illustrates snippets built in a snippet database,

FIG. 4 illustrates an original design file,

FIG. 5 illustrates in-screen elements distinguished as a result of AI analysis and a snippet matching result,

FIG. 6 illustrates a snippet recommendation screen,

FIG. 7 illustrates a combination result of confirmed snippet information and original design elements, and

FIG. 8 exemplarily illustrates a configuration of a system according to one embodiment of the present invention.

### DETAILED DESCRIPTION

As the present invention can be variously modified and have various embodiments, specific embodiments will be illustrated in the drawings and described in detail. However, this is not intended to limit the present invention to a specific embodiment, and it should be understood to include all modifications, equivalents, and substitutes included in the spirit and technical scope of the present invention.

When an element is referred to as being “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

Terms such as first, second, etc., may be used to refer to various elements, but, these element should not be limited due to these terms. These terms will be used to distinguish one element from another element.

The terms used in this specification are intended to merely describe specific embodiments, but not intended to limit the invention. A singular expression includes a plural expression, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

In this disclosure, the term “unit” refers to a unit implemented by hardware, a unit implemented by software, or a unit implemented by a combination of both. A single unit may be realized using two or more hardware components, and conversely, two or more units may be realized by a single hardware component. In addition, the term “unit” is not meant to be limited to software or hardware, and the “unit” may be configured to reside on an addressable storage medium or may be configured to execute one or more processors. Thus, in one example, “~unit” may include components, such as software components, object-oriented software components, class components, and task components, as well as processes, functions, properties, procedures, subroutines, segments of program code, drivers, firmware, microcode, circuits, data, databases, data structures, tables, arrays, and variables. The functionality provided within the components and “~units” may be combined into fewer components and “~units” or further separated into additional components and “~subunits”. In addition, the components and “~units” may be implemented to cause one or more CPUs in the device to execute.

In addition, elements of an embodiment described with reference to each drawing is not limitedly applied only to the corresponding embodiment, but may be implemented to be included in another embodiment within a scope in which the technical spirit of the present invention is maintained. Furthermore, even if particular descriptions are omitted, it is apparent that multiple embodiments may be integrated and re-implemented as a single embodiment.

In describing the present invention with reference to the accompanying drawings, identical or related reference numerals are assigned to identical components regardless of the drawing numbers, and redundant descriptions thereof will be omitted. In explaining the present invention, if detailed descriptions of related known technologies are deemed to unnecessarily obscure the gist of the invention, such detailed descriptions will be omitted.

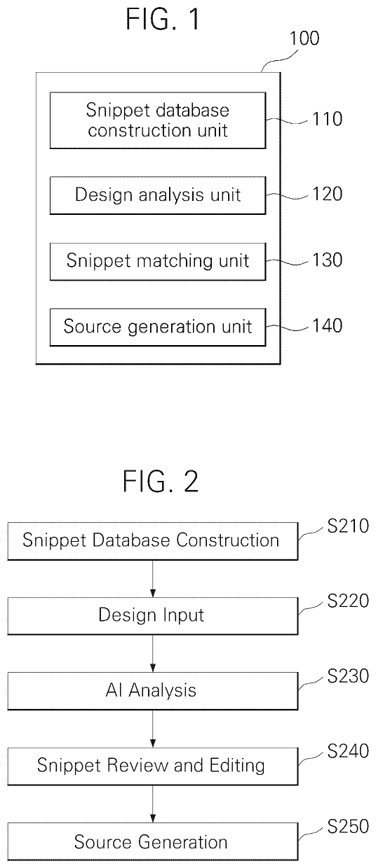

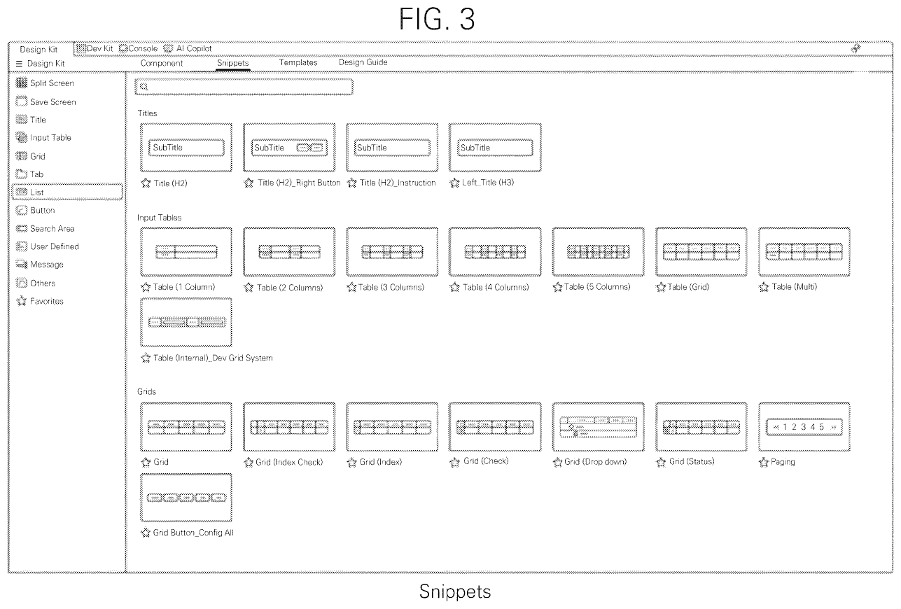

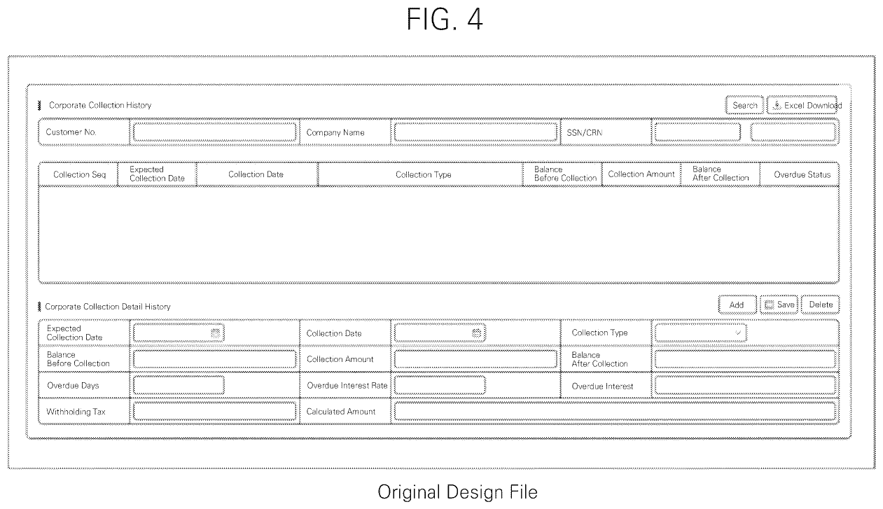

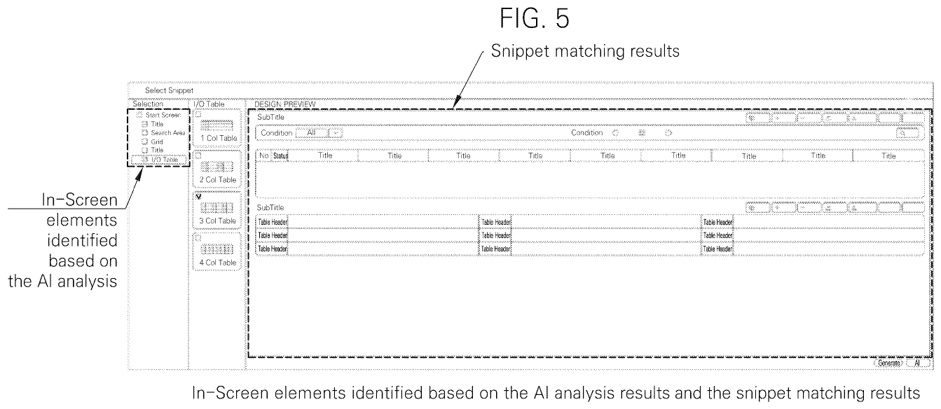

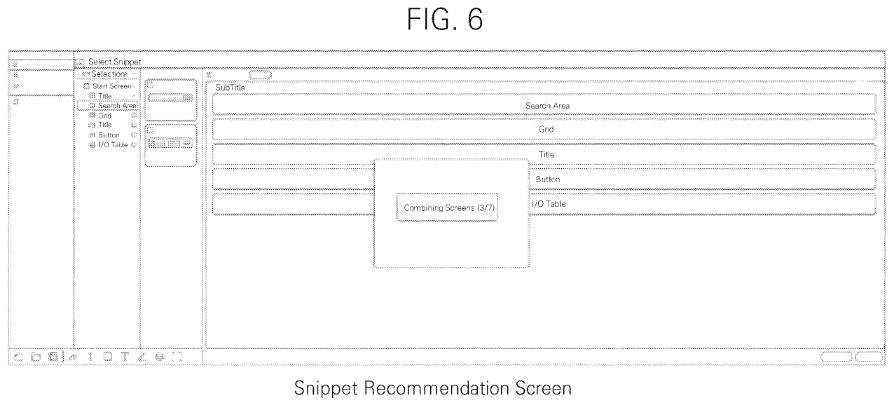

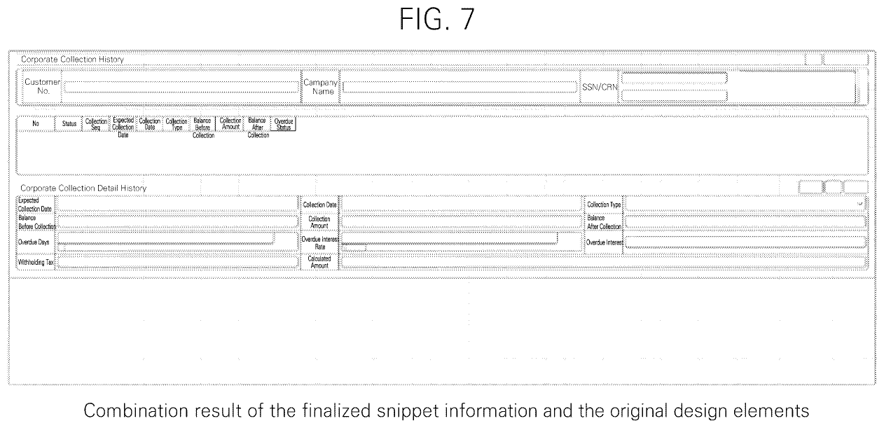

FIG. 1 illustrates an AI-based system for automatic UI/UX generation according to one embodiment of the present invention, FIG. 2 is a flowchart of an AI-based method for automatic UI/UX generation according to one embodiment of the present invention, FIG. 3 illustrates snippets built in a snippet database, FIG. 4 illustrates an original design file, FIG. 5 illustrates in-screen elements distinguished as a result of AI analysis and a snippet matching result, FIG. 6 illustrates a snippet recommendation screen, and FIG. 7 illustrates a combination result of confirmed snippet information and original design elements.

According to one embodiment of the present invention, AI-based system and method for automatic UI/UX generation belong to the field of UI/UX development including web applications or mobile applications, and is characterized in that design outputs (such as images or Figma files) are analyzed and matched by utilizing AI technology, and are automatically converted into standardized UI/UX sources.

Referring to FIG. 1, an AI-based system 100 for automatic UI/UX generation according to one embodiment may include a snippet database construction unit 110, a design analysis unit 120, a snippet matching unit 130, and a source generation unit 140.

In S210, the snippet database construction unit 110 is configured to build a database for snippets defining basic units used to configure UI/UX.

A snippet is a predefined basic unit (such as layouts, components, or UI patterns) frequently used when configuring UI or UX. For example, buttons, tables, input forms, card types, tabs may be included in the snippet (see FIG. 3).

When constructing a snippet database, design guidelines determined for each company or project may be applied in advance in snippets such as tables, buttons, and input forms. The design guidelines may include color, spacing, font, layout rules, and the like.

Additionally, similar snippets may be grouped when constructing the snippet database. Such grouping of snippets is categorizing the snippets so that they can be conveniently managed and used. The similarity of snippets may be determined by considering functional features and visual features.

Various variations within each group (such as icon buttons or expansion tables) may be stored together with metadata. The metadata may include text explaining the function of the corresponding snippet and information on the components used. Other information may also be further included in the metadata if necessary.

In S220, the design analysis unit 120 is configured to receive an original design file regarding an original screen image from a user. Then, in S230, the input original design file is analyzed by AI.

The user may be a web designer or an application developer.

The design file may be an image file having a file format such as PNG or JPG. Alternatively, the design file may be a JSON/SVG file exported from a design tool (such as Figma).

An example of the original design file is shown in FIG. 4. As a screen to be developed, types, positions, sizes, and shapes of in-screen elements may be identifiable.

When the design analysis unit 120 is configured to analyze the design file, an AI model may be utilized. The AI model may be a machine learning model or a deep learning model.

The AI model is configured to analyze the design file to identify in-screen elements. The in-screen elements may include buttons, text, forms, and tables.

Then, the AI model is configured to extract and classify attributes such as coordinates, size, color, and font of the identified elements.

In-screen elements identified as a result of the AI analysis and a snippet matching result are shown in FIG. 5.

In S240, the snippet matching unit 130 may recommend (in other words, match) the most suitable snippet or a candidate list by comparing analyzed information with snippets stored in the previously constructed snippet database. Referring to FIG. 6, a screen for recommending a snippet is illustrated.

The recommended criteria may include: containing a majority of the in-screen elements identified through classification; and having the smallest error in the comparison values of attributes such as coordinates, size, color, and font for each in-screen element.

The snippet matching unit 130 is configured to provide a snippet matching result recommended by the AI model in the design analysis unit 120 by visualizing the result as a UI.

The user checks the corresponding matching result and, if necessary, may make the actually desired UI configuration consistent with the design guidelines by editing the recommended snippet through modification, addition, or deletion.

The source generation unit 140 is configured to combine snippet information reviewed and edited (that is, confirmed by the user) in the snippet matching unit 130 and original design elements. Referring to FIG. 7, a combination result of the confirmed snippet information and the original design elements is illustrated.

Then, in S250, a UI/UX source (such as HTML, CSS, JavaScript or other UI framework code) embedding the design guidelines is automatically generated.

The source code thus generated is implemented in a component structure capable of being reused, and can be readily utilized for future development of similar screens.

According to the system and method of one embodiment, compliance with design guidelines can be achieved. Since the snippet database itself reflects the design guidelines, the automatically generated source code can meet consistent UI guidelines.

Additionally, maintenance costs can be reduced. Since the source code is generated based on standardized snippets rather than simple histogram (pixel area) analysis, the burden of additional modification can be significantly reduced.

Furthermore, development productivity may be enhanced. Since the AI automatically classifies UI elements and matches appropriate snippets, the time for repetitive works is reduced, and the overall project development speed may be increased.

Additionally, consistent code quality can be maintained. Since the same snippet database is referenced for generation in all projects, the UI style and structure are unified, and the code quality can be uniformly maintained.

Furthermore, scalability and compatibility can be secured. It can be linked with various design tools (such as Figma, Sketch, or Adobe XD), and design guidelines can be gradually expanded by adding new snippets.

In the system and method according to one embodiment, UI/UX sources (such as HTML, CSS, or JavaScript) to which design guidelines are applied can be automatically generated by analyzing results generated from image or design tools such as Figma.

Furthermore, by using a pre-constructed standardized snippet database and AI analysis techniques, efficient and consistent UI/UX screens can be rapidly implemented in real-world environment, and maintenance costs can be significantly reduced.

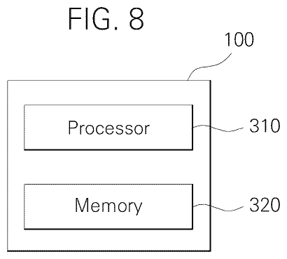

FIG. 8 exemplarily illustrates a configuration of a system according to one embodiment of the present invention.

Referring to FIG. 8, the system 100 may include a processor 310 and a memory 320. The memory 320 may store one or more instructions executable by the processor 310. The processor 310 may executes the one or more instructions stored in the memory 320. The processor 310 may execute the one or more operations described above by executing the instructions. In addition, the configuration of the present invention described above with reference to FIG. 3 may be a configuration implemented by instructions executed by the processor 310.

The embodiments described above may be implemented by hardware components, software components, and/or a combination of hardware components and software components. For example, the devices, methods, and components described in the embodiments may be implemented using one or more general-purpose computers or special-purpose computers, such as, for example, a processor, a controller, a Central Processing Unit (CPU), a Graphics Processing Unit (GPU), an Arithmetic Logic Unit (ALU), a Digital Signal Processor (DSP), a microcomputer, a Field Programmable Gate Array (FPGA), a Programmable Logic Unit (PLU), a microprocessor, Application Specific Integrated Circuits (ASICS), or any other device capable of executing and responding to instructions.

The above-described AI-based method for automatic UI/UX generation may also be implemented in the form of a recording medium including instructions executable by a computer, such as an application or program module executed by a computer. The computer-readable medium can be any available medium that can be accessed by a computer and includes both volatile and nonvolatile media, removable and non-removable media. In addition, the computer-readable medium may include a computer storage medium. The computer storage medium includes both volatile and nonvolatile, removable and non-removable media implemented in any method or technology for storage of information such as computer readable instructions, data structures, program modules or other data.

The above-described AI-based method for automatic UI/UX generation may be executed by an application (which may include a program included in a platform or operating system by default installed in the terminal) installed by default in the terminal, and by an application (i.e., program) that a user manually installed in the terminal after downloading from an application store server, or an application providing server such as a web server related to the application or service. In this sense, the above-described AI-based method for automatic UI/UX generation may be implemented as an application (i.e., program) installed by default in the terminal or manually installed by a user, and may be recorded in the non-transitory computer-readable recording medium such as the terminal.

While the invention has been described above with reference to exemplary embodiments, it will be understood by those skilled in the art that the invention can be modified and changed in various forms without departing from the concept and scope of the invention described in the appended claims.

What is claimed is:

1. A non-transitory computer-readable medium storing computer executable instructions for performing an AI-based method for automatic UI/UX generation when executed by a computer, wherein the instructions cause the computer to perform the following steps:
building a snippet database including a plurality of snippets that comply with design guidelines;
receiving an original design file;
analyzing the original design file using an AI model;
matching a snippet corresponding to a designated recommendation criteria among the plurality of snippets stored in the snippet database based on the analysis results; and
automatically generating a UI/UX source embedding the design guidelines by combining information on the matched snippet and elements of the original design file,
wherein in the building of the snippet database, the snippets similar to each other above a threshold are grouped in consideration of functional features and visual features,
wherein in the analyzing of the original design file, the AI model is configured to analyze the original design file to distinguish an in-screen element, and extract and classify one or more attributes among coordinates, size, color, and font of the in-screen element,
wherein in the matching of the snippet, the recommendation criterion is at least one of containing a majority of the in-screen elements or having the smallest error in the comparison values of attributes such as coordinates, size, color, and font for each in-screen element within the group to which the snippet belongs.

2. The non-transitory computer-readable medium of claim 1, wherein the snippet is a predefined basic unit used when configuring UI or UX and the design guidelines include at least one of color, spacing, font, or layout rules.

3. The non-transitory computer-readable medium of claim 1, wherein the original design file is one or more of an image file and a file in a designated format exported from a design tool.

4. The non-transitory computer-readable medium of claim 1, further comprising:
providing a matching result of the snippet by visualizing the result as a UI after the matching of the snippet; and
editing the snippet by a user input.

5. An AI-based system for automatic UI/UX generation, comprising:
a snippet database construction unit configured to build a snippet database including a plurality of snippets that comply with design guidelines;
a design analysis unit configured to receive an original design file and analyzing the original design file using an AI model;
a snippet matching unit configured to match a snippet corresponding to a designated recommendation criteria among the plurality of snippets stored in the snippet database based on the analysis results; and
a source generation unit configured to automatically generate a UI/UX source embedding the design guidelines by combining information on the matched snippet and elements of the original design file,
wherein the snippet database is configured to group the snippets similar to each other above a threshold in consideration of functional features and visual features,
wherein the AI model is configured to analyze the original design file to distinguish an in-screen element, and extract and classify one or more attributes among coordinates, size, color, and font of the in-screen element,
wherein the recommendation criterion is at least one of containing a majority of the in-screen elements or having the smallest error in the comparison values of attributes such as coordinates, size, color, and font for each in-screen element within the group to which the snippet belongs.

6. The AI-based system of claim 5, wherein the snippet matching unit is further configured to provide a matching result of the snippet by visualizing the result as a UI after the matching of the snippet and edit the snippet by a user input.
